(19) United States
(12) Patent Application Publication
(10) Pub. No.: US 2022/0123343 A1
(43) Pub. Date: Apr. 21, 2022

(54) A Mixed-Flow Architecture for a Flow Battery

(71) Applicant: Delectrik Systems Private Limited, Haryana (IN)

(72) Inventor: Sunil Bhat, Haryana (IN)

(21) Appl. No.: 17/310,785

(22) PCT Filed: Feb. 17, 2020
(86) PCT No.: PCT/IB2020/051297

§ 371 Date: Aug. 24, 2021

(30) Foreign Application Priority Data
Mar. 2, 2019 (IN) 201911008208

(51) Int. Cl. H01M 8/18; H01M 8/0234; H01M 8/0247; H01M 8/0263

(52) U.S. Cl. CPC H01M 8/188; H01M 8/0263; H01M 8/0247; H01M 8/0234

(57) ABSTRACT

A flow battery with a mixed-flow architecture comprising two electrodes separated by a membrane. The electrodes and membrane are sandwiched between a pair of bipolar plates. The architecture comprises a flow-field disposed between each of the electrodes and the membrane, wherein each flow-field is configured with channels for the flow of electrolyte. The flow fields can be made of any electrically non-conducting and acid resistant material such as PE, PP, PVDF and PTFE, or any other acid resistant plastic. The flow-fields are porous to enable ion conductivity. The presence of the flow-fields enables reduction in the thickness of the electrodes and bipolar plates thereby decreasing the ohmic loss and the cost.

### CROSS-REFERENCE TO RELATED APPLICATIONS

This is a national phase application of, and claims priority to International Application No. PCT/IB2020/051297, filed Feb. 17, 2020, which designated the U.S. and which claims priority to Indian Application No. 201911008208, filed Mar. 2, 2019.

### TECHNICAL FIELD

The present disclosure generally relates to the field of redox flow batteries. In particular, the present disclosure relates to a “mixed-flow” flow battery architecture that improves performance and reduces cost.

### BACKGROUND

Background description includes information that may be useful in understanding the present invention. It is not an admission that any of the information provided herein is prior art or relevant to the presently claimed invention, or that any publication specifically or implicitly referenced is prior art.

Flow Battery (FB), also known as Redox Flow Battery is an energy storage system which stores energy in the form of chemical energy and converts it into electrical energy by a reduction-oxidation (redox) reaction. In a FB, the energy is stored and determined based on the amount and concentration of electrolyte present in the system which is stored in external tanks. Here, no electro-deposition or loss in electroactive substances takes place when the battery is repeatedly cycled, thereby significantly increasing its lifetime, compared to conventional solid-state batteries.

The FB system comprises of three key elements: the electrolyte, which determines the amount of energy in the system is typically stored in two separate tanks, consisting of a positive electrolyte or catholyte and negative electrolyte or the anolyte; the stack, which determines the power of the system and consists of one or more cells typically connected electrically in series and fluidically in parallel; and the Balance of Plant (BOP), which includes other components such as pumps which feed the electrolyte from the tanks to the stack, plumbing through which the electrolyte flows and a battery management system consisting of sensors, control circuit for the overall system.

Of particular interest are all-vanadium redox flow batteries (VRFBs). In this type of flow battery, the positive electrolyte contains VO₂⁺ ions which undergo a reduction reaction to VO²⁺ plus electricity during its discharge cycle. The opposite oxidation reaction takes place during the charging of the battery, where VO²⁺ ion plus electricity are oxidised back to VO₂⁺ ions. In the negative electrolyte V²⁺ ions undergo an oxidation reaction to yield V³⁺ ions plus electricity during its discharge cycle. During the charging cycle V3+ ions plus electricity in the negative electrolyte is reduced back to V2+ ions.

In a commonly used cell design also referred to as “flow-through” deign, the electrolyte from tanks is circulated though the electrodes Such a design requires the electrode to be sufficiently thick and porous in order to minimize the pressure drop across the cell. The electrodes in such type of design are carbon foam or graphite felt. Due to the increased thickness the ionic and electronic resistance of the electrode increases.

In order to overcome the above-stated limitations, another set of designs have been used, where an electrolyte is circulated through a flow-field that is placed adjacent to the electrodes and between the bipolar plate and electrode. Since the electrolyte flow path is mainly through the flow-field, it allows use of thinner electrode such as carbon paper or cloth. This design can be referred to as “Flow-by” design.

The electrolyte used in flow batteries typically use strong mineral acids like sulfuric acid and hydrochloric acid. The flow-field should, along with high electrical conductivity and an appropriate design, have a high corrosion resistance.

In some designs the bipolar plates themselves have inbuilt flow channels to provide the flow path. The bipolar plates also transfer current from one cell to another or to the external current collector. This requires the bipolar plates to made of a material with high electronic conductivity. Also, depending upon the flow field design the material should be machinable. This can limit the materials which can be used for flow-fields in a flow battery to those such as graphite, and, this is likely to significantly increase cost.

There is therefore a requirement in the art for a flow battery cell design to improve performance without impacting cost.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities or dimensions of items, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all groups used in the appended claims.

### Objects

A general object of the present disclosure is to provide a flow battery with a mixed-flow architecture.

Another object of the present disclosure is to provide a flow battery with electrically non-conducting and ionically conducting flow-fields.

Another object of the present disclosure is to provide a flow battery with thinner electrodes.

Another object of the present disclosure is to provide a flow battery with thinner bipolar plates.

Another object of the present disclosure is to provide a flow battery with an integrated flow-field and membrane assembly.

Another object of the present disclosure is to provide a flow battery which improves performance and reduces cost.

### SUMMARY

The present disclosure generally relates to the field of redox flow batteries. In particular, the present disclosure relates to a “mixed-flow” flow battery architecture that improves performance and reduces cost.

In an aspect, the present disclosure provides an architecture for a flow battery, said architecture comprising: two electrodes, a negative electrode and a positive electrode; a membrane; two bipolar plates; two flow-fields; a negative electrolyte; and a positive electrolyte.

In another aspect, the membrane is disposed between the negative electrode and the positive electrode and is coupled to each of the negative electrode and positive electrode at an inner end of the electrodes, said membrane configured to permit diffusion of ions through it.

In another aspect, the two bipolar plates are each disposed at an outer end of each of the two electrodes and each are electrically coupled to the respective electrode.

In another aspect, the two flow-fields, each comprising a plurality of channels are configured for fluid flow, and each are configured between each of the two electrodes and the membrane, and each flow-field is further configured to conduct ions, wherein each of the two flow-fields is fluidically coupled to the respective electrode and ionically coupled to the membrane and to the respective electrode.

In another aspect, the negative electrolyte is configured to flow through the flow-field fluidically coupled to the negative electrode. In another aspect, the positive electrolyte is configured to flow through the flow-field fluidically coupled to the positive electrode.

In another aspect, the flow-fields reduce dependency of electrolyte flow in the in-plane direction of the electrode and, thereby enable use of thinner electrodes, respectively. In another aspect, the flow-field, due to their location, do not conduct electrons, thereby enabling the use of electrically non-conducting material for flow-field construction.

In an embodiment, the two flow-fields are porous and are made of any electrically non-conducting material selected from a group consisting of polyethylene (PE), polypropylene (PP), polytetrafluoroethylene (PTFE), polyvinylidene difluoride (PVDF) and other acid resistant plastics.

In another embodiment, the plurality of channels are of different configuration selected from any or a combination of mesh, parallel, interdigitate and serpentine.

In another embodiment, the two flow fields are made of the same material as the membrane.

In another embodiment, any or both of the two flow fields is integrated with the membrane to form one assembly.

In another embodiment, the two flow fields are comprised within the membrane, the plurality of channels of each of the two flow fields extending through the thickness of the membrane, wherein the plurality of channels allow the flow of electrolyte in the in-plane direction of the membrane and, wherein the membrane allows conduction of ions across its thickness.

In another embodiment, any or both of the two bipolar plates is integrated with the respective electrode to form one assembly.

In another embodiment, the two bipolar plates are made of a carbon-based material.

In another embodiment, the two electrodes are made of a carbon-based material.

In another embodiment, any or both of the two electrodes is porous.

Various objects, features, aspects and advantages of the inventive subject matter will become more apparent from the following detailed description of preferred embodiments, along with the accompanying drawing figures in which like numerals represent like components.

### BRIEF DESCRIPTION OF DRAWINGS

The accompanying drawings are included to provide a further understanding of the present invention and are incorporated in and constitute a part of this specification. The drawings illustrate exemplary embodiments of the present invention and, together with the description, serve to explain the principles of the present invention.

FIG. 1 illustrates a typical representation of a flow battery unit with a “Flow-through” design, as known in the art.

FIG. 2 illustrates a typical representation of a flow battery unit with a “Flow-by” design, as known in the art.

FIG. 3 illustrates an exemplary representation of a flow battery unit with a “Mixed-flow” design, in accordance with embodiments of the present disclosure.

FIG. 4 illustrates typical configurations of flow channels in the flow-fields, known in the art.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. These exemplary embodiments are provided only for illustrative purposes and so that this disclosure will be thorough and complete and will fully convey the scope of the invention to those of ordinary skill in the art. The invention disclosed may, however, be embodied in many different forms and should not be construed as limited to the embodiments set forth herein. Various modifications will be readily apparent to persons skilled in the art. The general principles defined herein may be applied to other embodiments and applications without departing from the spirit and scope of the invention. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure). Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Embodiments described herein relate generally relates to the field of redox flow batteries, and in particular, to a “mixed flow” flow battery architecture that improves performance and reduces cost.

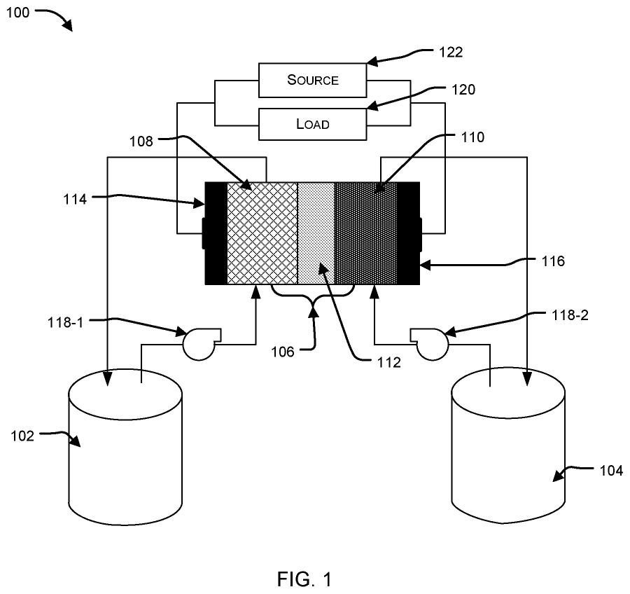

FIG. 1 illustrates a typical representation of a flow battery unit with a “Flow-through” design, as known in the art. In an aspect, the flow battery unit 100 (hereinafter, also referred to as “battery”) broadly comprises: a tank 102 containing a negative electrolyte; a tank 104 containing a positive electrolyte; and an electrochemical cell 106 (hereinafter, also referred to as “cell”). In an embodiment, the tanks 102, 104 are fluidically coupled to the cell 106.

In another aspect, the cell 106 comprises a negative electrode 108 and a positive electrode 110. In an embodiment, the negative electrode 108 and the positive electrode 110 can be porous and each can be adapted to allow the negative electrolyte and positive electrolyte to flow through it respectively. In another embodiment, the negative electrode 108 and positive electrode 110 can be separated by a membrane 112. In another embodiment, the membrane 112 can be an ion exchange membrane or a microporous separator.

In another embodiment, the electrodes 108, 110 and membrane 112 assembly can be sandwiched between a negative bipolar plate 114 and a positive bipolar plate 116. The bipolar plates are electrically conductive plates and are so termed because, when a plurality of cells are connected in a stack, in series, two adjacent cells share a common bipolar plate—the bipolar plate is connected to the cathode of one cell and the anode of the adjacent cell. In another embodiment, the bipolar plates can be made of a conducting material such as graphite.

In an aspect, the electrolyte can be pumped from the tanks 102, 104 into the cell 106 by two or more pumps. Typically, a sperate pump 118-1, 118-2 are used to pump negative electrolyte and positive electrolyte respectively.

In another aspect, during operation, the electrolytes are continuously circulated through the cell 106. Ion exchange occurs between the negative electrolyte and the positive electrolyte through the membrane 112, and electron transfer occurs from the electrodes 108, 110 to the bipolar plates 114, 116.

In another aspect, the bipolar plates 114, 116, in turn, are connected to an external load 120 (during battery discharge) or an external source 122 (during battery charge) through a current collector each which can be made of a metallic conductor such as Copper.

In another aspect, the above described battery design is referred to as “Flow-through” design, as the electrolytes are circulated to “flow through” the respective electrodes. However, in order that the pressure-drop as the electrolytes flow through the respective electrodes does not affect the efficiency of the redox reaction occurring at the electrodes, the electrodes are typically made sufficiently thick and porous. This increased thickness has a detrimental effect on the ionic and electrical conductivity of the electrodes. Moreover, once the electrodes are made of materials such as carbon foam or graphite, the expenses in forming thick electrodes is also high.

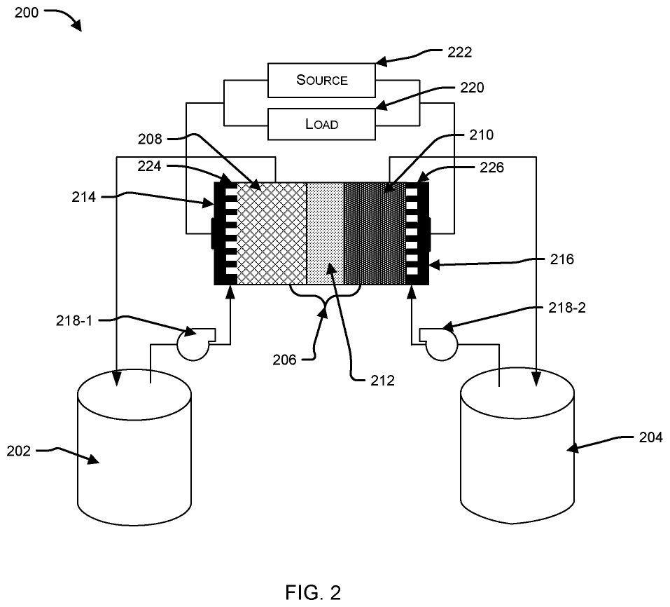

In order to overcome the limitation as expressed above, an alternate design for a battery can be employed, referred to as “Flow-by” design. FIG. 2 illustrates a typical representation of a flow battery unit with a “Flow-by” design, as known in the art. In an aspect, the flow battery unit 200 (hereinafter, also referred to as “battery”) is similar in construction to a “Flow-through” battery 100. The battery 200 comprises: a tank 202 containing a negative electrolyte; a tank 204 containing a positive electrolyte; and an electrochemical cell 206 (hereinafter, also referred to as “cell”). In an embodiment, the tanks 202, 204 are fluidically coupled to the cell 206. In another embodiment, the cell 206 comprises a negative electrode 208 and a positive electrode 210. In another embodiment, the negative electrode 208 and positive electrode 210 can be separated by a membrane 212.

In another embodiment, the electrodes 208, 210 and membrane 212 assembly can be sandwiched between a negative bipolar plate 214 and a positive bipolar plate 216.

In another embodiment, the “flow-by” battery 200 differs from the “flow-through” battery 100 in that it comprises a flow-field (224, 226) disposed adjacent to each of the negative electrode 208 and the positive electrode 210 and between the respective bipolar plates (214, 216), where the flow-fields (224, 226) are configured for the flow of electrolytes. The “flow-by” battery is termed so since, here, the electrolytes “flow by” the electrodes.

In another embodiment, since the electrolyte flow happens primarily thorough the flow-fields (224, 226), the electrodes (208, 210) are not required to be thick and porous and can be made thinner. This can result in improved ionic and electrical conductance and also in reducing costs for manufacture of the electrodes. In another embodiment, the negative electrode 208 and the positive electrode 210 can be porous such that the electrolyte flowing through the respective flow-fields (224, 226) can also be forced through the electrodes (208, 210).

In another embodiment, the bipolar plates themselves can be machined to incorporate the flow-fields.

In an aspect, the electrolyte can be pumped from the tanks 202, 204 into the cell 206 by two or more pumps. Typically, a sperate pump 218-1, 218-2 are used to pump negative electrolyte and positive electrolyte respectively.

In another aspect, during operation, the electrolytes are continuously circulated through the flow-fields (224, 226). Ion exchange occurs between the negative electrolyte and the positive electrolyte through the membrane 212, and electron transfer occurs from the electrodes 208, 210 to the bipolar plates 214, 216. In another aspect, the bipolar plates 114, 116, in turn, are connected to an external load 220 (during battery discharge) or an external source 222 (during battery charge).

In another aspect, the use of highly acidic electrolytes, in this case as well, requires the flow-field material to be electrically conductive as well as resistant to acid attack. Typically, the flow-fields is made of material such as graphite.

In another aspect, for flow-fields to be effective, they generally require a complex geometric configuration of channels to carry the electrolyte through them, and this results in a requirement to machine the channels on to a block of material that the flow-field will be made of Since this material is graphite, and machining of graphite is expensive, this design of “flow-by” batteries can become expensive.

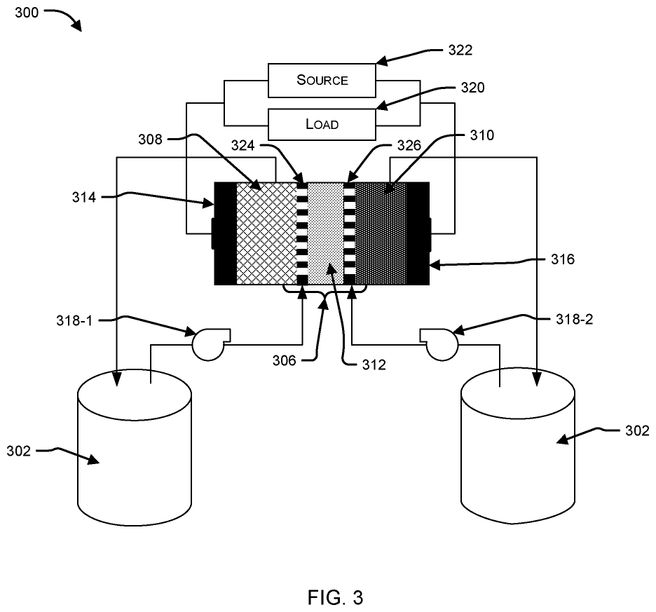

FIG. 3 illustrates an exemplary representation of a flow battery unit with a “mixed-flow” design, in accordance with embodiments of the present disclosure. In an embodiment, the battery 300 comprises: a tank 302 containing a negative electrolyte; a tank 304 containing a positive electrolyte; and an electrochemical cell 306 (hereinafter, also referred to as “cell”). In an embodiment, the tanks 302, 304 are fluidically coupled to the cell 306. In another embodiment, the cell 306 comprises a negative electrode 308 and a positive electrode 310. In another embodiment, the negative electrode 308 and positive electrode 310 can be separated by a membrane 312.

In another embodiment, the electrodes (308, 310) and membrane 312 assembly can be sandwiched between bipolar plates 314 and 316.

In another embodiment, the battery 300 comprises flow-fields (324, 326) disposed on either side of the membrane 312 and in between the negative electrode 308 and positive electrode 310 respectively. The flow-fields (324, 326) are configured for flow of electrolytes. In another embodiment, the negative electrode 308 and the positive electrode 310 can be porous such that the electrolyte flowing through the respective flow-fields (324, 326) can also be forced through the electrodes (308, 310).

In another embodiment, because the flow-fields (324, 326) are coupled to the membrane, they are required to be permeable to the flow of ions. Further, since the flow-fields (324, 326) are not part of a current collecting circuit (electrode to bipolar plate), they are not required to be electrically conducting. This enables the use of common plastics, which also show resistance to acid, such as polyethylene (PE), polypropylene (PP), polytetrafluoroethylene (PTFE), polyvinylidene difluoride (PVDF) etc. Further, these materials can be easily manufactured to a desired configuration, thereby reducing manufacturing costs. Complex shapes can also be manufactured using moulding techniques.

In another embodiment, in order for the flow-fields (324, 326) to be ionically conductive, they can be porous in nature. This can also enable the use of thinner bipolar plates, as there is no need to machine the flow-field onto them for flow of the electrolyte. A flat sheet of graphite can be used as the bipolar plate.

In another embodiment, as the flow-fields (324, 326) can be made of the same material as the membrane and are integrated with the membrane 312 to form an integrated flow-field and membrane assembly.

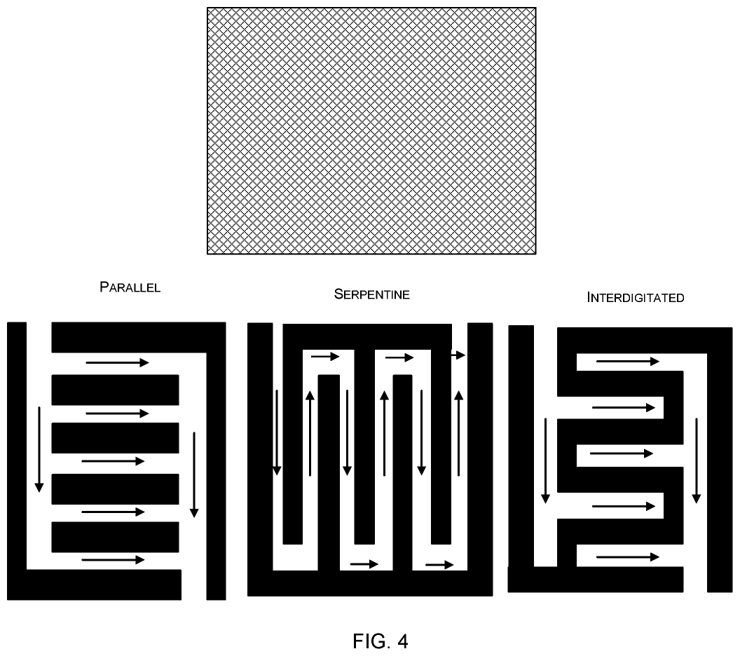

In another embodiment, to enhance the interaction of the electrolyte with the electrode (308, 310), the flow-field (324, 326) can have different configurations to force the electrolyte into the electrodes. FIG. 4 illustrates typical configurations of flow channels in the flow-fields, known in the art. The configurations such as mesh, parallel, serpentine and interdigitated can be used alone or in combination with one another.

Thus, the present disclosure provides a flow battery architecture based on the mixed-flow design that can use a cost-effective flow-field to enable reduction in the thickness of the electrode without compromising on the ionic conductivity and electrical conductivity of the flow battery. The use of materials like PE, PP, PTFE and PVDF further enables complex shapes and geometries to be formed easily without increasing costs.

It should be apparent to those skilled in the art that many more modifications besides those already described are possible without departing from the inventive concepts herein. The inventive patient matter, therefore, is not to be restricted except in the spirit of the appended claims. Moreover, in interpreting both the specification and the claims, all terms should be interpreted in the broadest possible manner consistent with the context. In particular, the terms “includes” and “including” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc. The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practised with modification within the spirit and scope of the appended claims.

While the foregoing describes various embodiments of the invention, other and further embodiments of the invention may be devised without departing from the basic scope thereof The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### Advantages

The present disclosure provides a flow battery with a mixed-flow architecture.

The present disclosure provides a flow battery with electrically non-conducting and ionically conducting flow-fields.

The present disclosure provides a flow battery with thinner electrodes.

The present disclosure provides a flow battery with thinner bipolar plates.

The present disclosure provides a flow battery with an integrated flow-field and membrane assembly.

The present disclosure provides a flow battery which improves performance and reduces cost.

We claim:

1. An architecture for a flow battery, said architecture comprising:
two electrodes, a negative electrode and a positive electrode;
a membrane, disposed between the negative electrode and the positive electrode and coupled to each of the negative electrode and positive electrode at an inner end of the electrodes, said membrane configured to permit diffusion of ions through it;
two bipolar plates, each disposed at an outer end of each of the two electrodes and each electrically coupled to the respective electrode;
two flow-fields, each comprising a plurality of channels configured for fluid flow, and each configured between each of the two electrodes and the membrane, each flow field further configured to conduct ions, wherein each of the two flow-fields is fluidically coupled to the respective electrode and ionically coupled to the membrane and to the respective electrode;
a negative electrolyte configured to flow through the flow-field fluidically coupled to the negative electrode; and
a positive electrolyte configured to flow through the flow-field fluidically coupled to the positive electrode, and
wherein the flow-fields reduce dependency of electrolyte flow in the in-plane direction of the electrode and, thereby enable use of thinner electrodes respectively, and
wherein the flow-fields, due to their location, do not conduct electrons, thereby enabling the use of electrically non-conducting material for flow-field construction.

2. The flow battery architecture as claimed in claim 1, wherein the two flow-fields are porous and are made of any electrically non-conducting material selected from a group consisting of polyethylene (PE), polypropylene (PP), polytetrafluoroethylene (PTFE), polyvinylidene difluoride (PVDF) and other acid resistant plastics.

3. The flow battery architecture as claimed in claim 1, wherein the plurality of channels are of different configuration selected from any or a combination of mesh, parallel, interdigitate and serpentine.

4. The flow battery architecture as claimed in claim 1, wherein the two flow fields are made of the same material as the membrane.

5. The flow battery architecture as claimed in claim 1, wherein any or both of the two flow fields is integrated with the membrane to form one assembly.

6. The flow battery architecture as claimed in claim 1, wherein the twoflow fields are comprised within the membrane, the plurality of channels of each of the two flow fields extending through the thickness of the membrane, wherein the plurality of channels allow the flow of electrolyte in the in-plane direction of the membrane and, wherein the membrane allows conduction of ions across its thickness.

7. The flow battery architecture as claimed in claim 1, wherein any or both of the two bipolar plates is integrated with the respective electrode to form one assembly.

8. The flow battery architecture as claimed in claim 1, wherein the two bipolar plates are made of a carbon-based material.

9. The flow battery architecture as claimed in claim 1, wherein the two electrodes are made of a carbon-based material.

10. The flow battery architecture as claimed in claim 1, wherein any or both of the two electrodes is porous.
